(19) United States
(12) Patent Application Publication
(10) Pub. No.: US 2018/0373387 A1
(43) Pub. Date: Dec. 27, 2018

(54) VISUAL INTERFACE SYSTEM

(71) Applicant: Slim HMI Technology, Taipei City (TW)

(72) Inventor: Hsiung-Kuang TSAI, Taipei City (TW)

(21) Appl. No.: 16/119,752

(22) Filed: Aug. 31, 2018

Related U.S. Application Data
(63) Continuation-in-part of application No. 15/488,965, filed on Apr. 17, 2017.
Application No. 15/488,965 is a continuation of application No. 14/344,462, filed on Mar. 12, 2014, now abandoned.

(51) Int. Cl. G06F 3/041; H04B 5/00; G06F 3/046; G06F 3/044; H04W 4/80; G06F 3/038; G06F 3/0354

(52) U.S. Cl. CPC G06F 3/0416; H04B 5/0031; G06F 3/0412; G06F 3/046; G06F 2203/04101; H04W 4/80; G06F 3/041; G06F 3/038; G06F 3/03545; G06F 3/044

(57) ABSTRACT

A short-range information broadcasting system is provided. The short-range information broadcasting system comprises a broadcaster and a receiver. The broadcaster comprises a display matrix, and the display matrix generates and broadcasts at least one information carrier. The information carrier comprises an image part and a data part, and the image part and the data part share common information. The receiver receives the data part of the information carrier.

### CROSS REFERENCE TO RELATED APPLICATIONS

The present application is a Continuation-In-Part application of U.S. application Ser. No. 15/488,965, which is a Continuation application of U.S. application Ser. No. 14/344,462, which is a 35 U.S.C. § 371 National Phase conversion of International (PCT) Patent Application No. PCT/CN2011/079576, filed on Sep. 13, 2011, the disclosure of which is incorporated by reference herein. The PCT International Patent Application was filed and published in Chinese. These and all other references are incorporated herein by reference in their entirety.

### BACKGROUND OF THE INVENTION

### Field of Invention

The present invention relates to a visual interface system and, in particular, to a short-range information broadcasting system.

### Related Art

Recently, touch panels have been widely applied to the commercial electronic products such as mobile phones, digital cameras, MP3, PDA, GPS, tablet PC, UMPC, and the likes. In these electronic products, the touch panel is bound with a screen to form a touch input display apparatus. A manufacturing method of a conventional touch input display apparatus is to dispose a touch panel on a display panel of a display module. However, due to the additional touch panel, this approach not only increases the weight and sized of the product, but also the cost.

In order to broaden the applications of the commercial electronic products, some products have been added with the new function of near field communication (NFC), which can be used to replace the conventional IC card (e.g. door card, credit card, ticket, and etc.), exchange information (e.g. music, image, name card, and etc.) between two electronic devices, or the likes. Accordingly, it is desired to create a product with a simple structure and more functions.

Also, since the development of computer, display and user input (such as keyboard or touchpad) are two basic components to support user-device interaction. People used to consider interaction as a bidirectional information exchange between user and graphic user interface (GUI) and the components are for converting information into various forms along each path, i.e., image data to image and action to input data. Two separate information flows are combined into a bi-directional interaction. In addition, the information forms in such modeling are incompatible with the data type information transmitted in device-device interaction. Thus, the user-device interaction and the device-device interaction were used to be treated as two different types of interaction.

Therefore, it is an important subject to provide a label-like framework to unify user-device and device-device interactions.

### SUMMARY OF THE INVENTION

In this disclosure, a label-like framework is provided to unify user-device and device-device interactions. The basic concept is to consider the two separate information flows, image and action detection, in user-device interaction or user input as one single flow because the action is always relied on the guidance of vision. Vision and action are dependent processes rather than independent. The interaction is same as we reach for an object and can be modeled as user establishing a channel so that information can flow from a source to receiver. User plays the role to establish channel rather than information source nor recipient. In this model, the information carrier has a composite structure that includes image and data. It is the same as an image labeled with data, or vice versa. Through this structure, information imitates a tangible object that has image and function. An information broadcasting structure is proposed to implement this user-device interaction model. Therefore, the interaction becomes a single information flow from source to receiver.

An objective of the present invention is to provide a short-range information broadcasting system. The short-range information broadcasting system comprises a broadcaster and a receiver. The broadcaster comprises a display matrix, and the display matrix generates and broadcasts at least one information carrier. The information carrier comprises an image part and a data part, and the image part and the data part represent the same information content. The receiver receives the data part of the information carrier.

In one embodiment, the receiver and broadcaster are located on the same device.

In one embodiment, the receiver is located on a surrounding of the broadcaster.

In one embodiment, the receiver and broadcaster are located on separate devices.

According to at least one inventive concept of this disclosure, in such short-range information broadcasting system, the same GUI will prepare the information for transmission and handle the received data as well. Both broadcaster and receiver are located on the same device. Or, the broadcaster and the receiver are located on the different devices. The user-device interaction (user input) and the device-device interaction (data transmission) can be treated as same information transmission process occurred in different broadcaster-receiver configurations. User input represents the information flows that source and receiver locate on that same device (intra-device configuration). When the broadcaster and receiver are located on different devices (called extra-device configuration), the information flow represents a short range data transmission (SRDT) similar to the operation of near field communication (NFC). Compared with NFC or data transmission that people used to consider, in this disclosure, it is emphasized that both image and data should be considered together in the process rather than data alone.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a block diagram of a visual interface system according to a first embodiment of the invention;

FIG. 2 is a side view of a matrix display apparatus according to the first embodiment of the invention;

FIG. 3 is a schematic diagram showing a TFT substrate used in the first embodiment of the invention;

FIG. 4 is a schematic diagram showing the signals for two row electrodes and two column electrodes of the TFT substrate of FIG. 3;

FIG. 5 is a timing chart of the encoded signal transmitted through each column electrode according to the first embodiment of the invention;

FIG. 6 is a perspective view of the matrix display apparatus of the visual interface system according to the first embodiment of the invention;

FIG. 7 is a schematic diagram showing the matrix display apparatus, a user and a data receiver as the operation apparatus, of the visual interface system according to the first embodiment of the invention; and

FIG. 8 is a block diagram of a visual interface system according to a second embodiment of the invention.

FIGS. 9A and 9B are two schematic diagrams of the short-range information broadcasting system according to the embodiments of this invention.

FIGS. 10A and 10B are two schematic diagrams that depict the broadcaster of the short-range information broadcasting system. According to the embodiment, broadcaster is a panel that can transmit data in addition to display image. In FIG. 10A which depicts the short-range information broadcasting system of an intra-device configuration, a coupling electrode surrounds the matrix can serve for picking up signal from finger input by coupling twice, from matrix to hand and hand to electrodes. A receiver then processes the signal for this intra-device transmission. In FIG. 10B, which depicts the short-range information broadcasting system in an extra-device configuration, the broadcaster can transmit data to a receiver on another device.

FIG. 11A depicts a sequence of pulses that represents a group of lines by encoding the line index in the pulse position. Each pulse represents a line independently. It is the same as transmitting n-bit data on each line for addressing all the lines.

FIG. 11B depicts a fast way to detect the present of a path. Half of the lines are assigned ‘1’ and shift ¼ line number successively. It corresponds to shrink the search region into half by transmitting 3-bit data on each line. Upon detection, we can narrow down to smaller region and apply the same process iteratively.

FIG. 12 is a schematic diagram according to according to the embodiments of this invention that illustrates the different roles that scan and data signal play in extra-device transmission. ‘A’ and ‘B’ are data to be transmitted from different locations on D2, D2/S1 and D2/S3. Receiver R1 and R2 will couple same data signals but different scan signals from these two locations. The scan signal(s) can be used as delimiter to separate data signals from these locations.

### DETAILED DESCRIPTION OF THE INVENTION

The present invention will be apparent from the following detailed description, which proceeds with reference to the accompanying drawings, wherein the same references relate to the same elements.

All publications herein are incorporated by reference to the same extent as if each individual publication or patent application were specifically and individually indicated to be incorporated by reference.

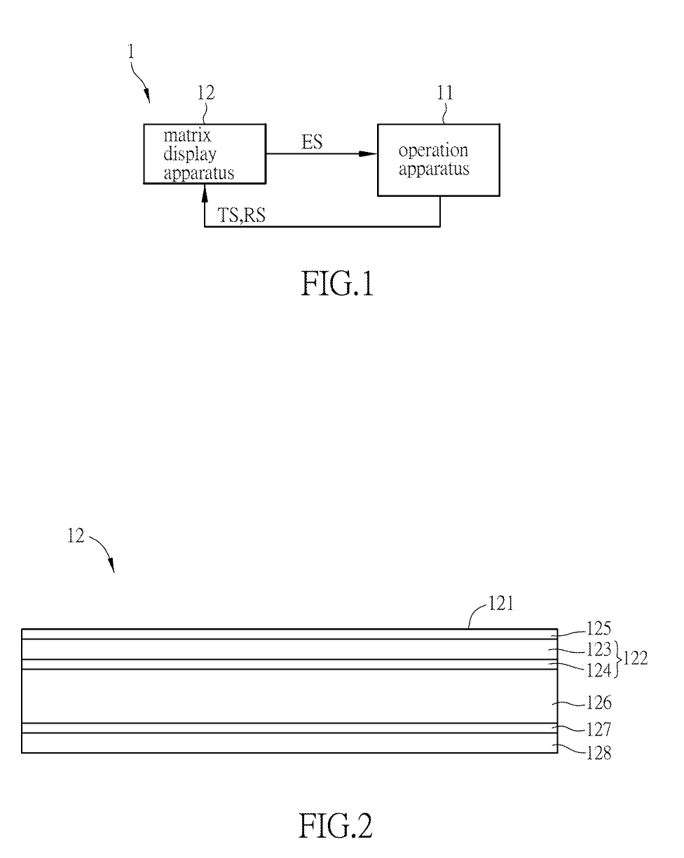

FIG. 1 is a block diagram of a visual interface system 1 according to a first embodiment of the invention. The visual interface system 1 includes an operation apparatus 11 and a matrix display apparatus 12, which are coupled with each other. For example, the operation apparatus 11 is capacitive coupled to the matrix display apparatus 12 for transmitting signals, which is a non-contact signal transmission.

In this embodiment, the operation apparatus 11 is, for example, a stylus, an IC card, or an NFC reading apparatus, or a data receiver. When the operation apparatus 11 is an electronic apparatus, it may include some functional circuits such as a process control circuit, a storage circuit or a transmission circuit. Herein, any circuit can be composed of hardware, software or firmware, or their combinations. When the operation apparatus 11 is a data receiver, user (especially the hand of a user) may serve as a conductor/or a wire for transmission signals between the matrix display apparatus 12 and the operation apparatus 11.

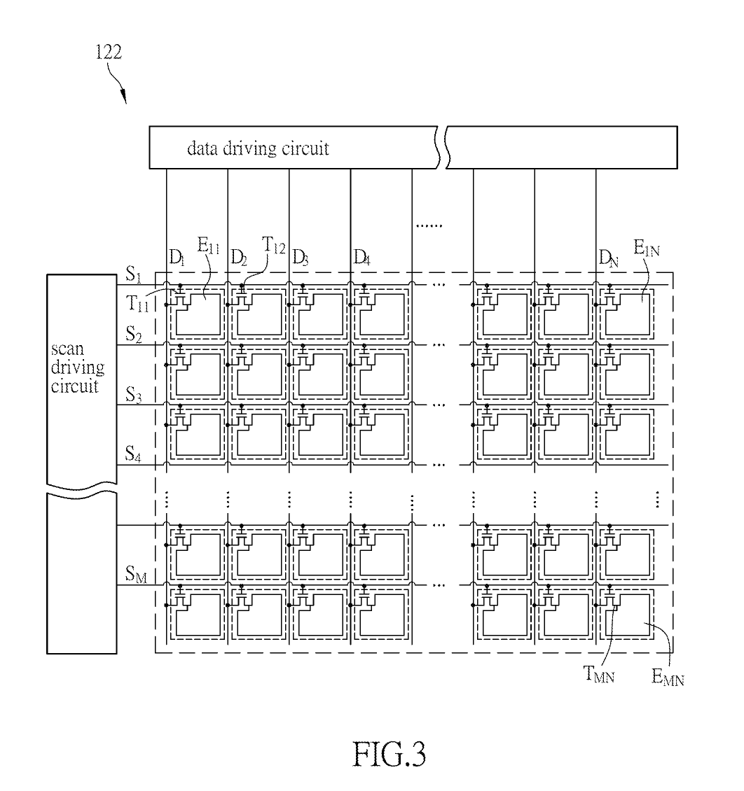

FIG. 2 is a side view of the matrix display apparatus 12. As shown in FIG. 2, the matrix display apparatus 12 has a display surface 121 and comprises a protect glass, a matrix substrate assembly 122, a display medium layer 126, a common electrode layer 127, and a bottom substrate 128. The matrix substrate assembly 122 includes an upper substrate 123 and a matrix 124. The matrix 124 is disposed at one side of the upper substrate 123, while the display surface 121 is located at the other side of the upper substrate 123. In this embodiment, the display surface 121 is the surface of the matrix display apparatus 12, which is closest to the viewer when the viewer is watching the images displayed on the matrix display apparatus 12. Besides, the matrix display apparatus 12 may further include a protect glass 125 disposed on one side of the upper substrate 123 opposite to the matrix 124. In this case, the display surface 121 is the surface of the protect glass closest to the viewer. Moreover, one side of the upper substrate 123 close to the protect glass 125 may be further configured with other components such as a polarizer, frame, or the likes. The common electrode layer 127 is disposed on one side of the bottom substrate 128 that facing toward the display medium layer 126. The display medium layer 126 is disposed between the matrix substrate assembly 122 and the bottom substrate 127, or, more specifically, between the matrix 124 and the common electrode layer 128. In this embodiment, the matrix display apparatus 12 is an active-matrix type of display panel. However, in other embodiment according to the inventive concept of this disclosure, the matrix display apparatus 12 can also be a passive type of display panel with different configurations. The display medium layer 126 can be liquid crystals, organic liquid crystals, electrophoretic substances and/or any other substances suitable for image display.

In this embodiment, the matrix substrate assembly 122 is a substrate configured with pixel matrix for displaying images, such as the TFT substrate of LCD panel, OLED panel, LED panel, electrophoretic panel, MEMS display panel, and the likes. The matrix 124 includes a plurality of row electrodes, a plurality of column electrodes, and a plurality of pixel electrodes, wherein the row electrodes and the column electrodes are intersected. Moreover, the matrix 124 can be an active matrix or a passive matrix. In this embodiment, the matrix 124 is an active matrix for example. Besides, the matrix 124 may further include a plurality of transistors electrically connected with the row electrodes, the column electrodes and the pixel electrodes, respectively.

The implementation of the embodiment used in the touch input purpose will be described hereinafter. Referring to FIGS. 1 and 2, when the operation apparatus 11 is operated on the display surface 121, an encoded signal ES is coupled to the operation apparatus 11 from the matrix substrate assembly 122, and the operation apparatus 11 receives the encoded signal ES so as to generate a transmission signal TS. Herein, the encoded signal ES contains the coordinates of the display screen of the matrix display apparatus 12, and the transmission signal TS contains the coordinate information. When the encoded signal ES is transmitted form the matrix substrate assembly 122 to the operation apparatus 11, they are wirelessly coupled so as to form a near field signal transmission. Of course, in other applications, the encoded signal can be composed of any information to be transmitted such as touch input information, instruction information, identification information, transaction information, or file information (e.g. music, images, texts, and etc.), so that the transmission signal TS contains the corresponding information.

The encoded signal ES is applied to the matrix substrate assembly 122, and additional display data signal is applied to the matrix substrate assembly 122 for displaying images. The encoded signal ES is applied during the blanking time of the display data signals. For example, the encoded signal ES can be applied between two frames or scan operations of two row electrodes, or during the gap generated as shortening the input time of the display signals. Or, the encoded signal ES can have a higher frequency and be directly added to the display signal.

The encoded signal ES and the transmission signal TS will be further described hereinbelow, wherein the matrix substrate assembly 122 is a TFT substrate of an LCD apparatus.

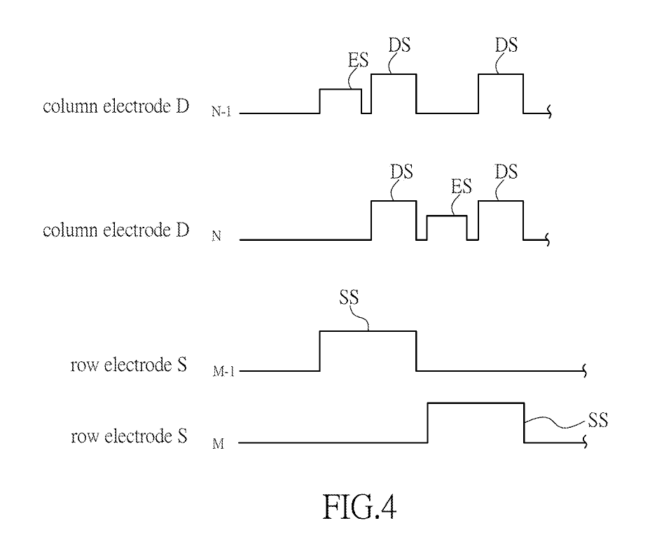

FIG. 3 is a schematic diagram showing a TFT substrate used in this embodiment. Referring to FIGS. 2 and 3, the matrix 124 includes a plurality of row electrodes S₁˜S_{M}, a plurality of column electrodes D₁˜D_{N}, and a plurality of pixel electrodes E₁₁˜E_{MN}. The row electrodes and the column electrodes are intersected and they are substantially perpendicular to each other or have an included angle. Moreover, the matrix 124 further includes a plurality of transistors for electrically connected with the row electrodes S₁˜S_{M}, column electrodes D₁˜D_{N}, and pixel electrodes E₁₁˜E_{MN}. The row electrodes S₁˜S_{M} are referred to scan lines, while the column electrodes D₁˜D_{N} are referred to data lines. Besides, the upper substrate 123 may further be configured with a driving module, which includes data driving circuit, scan driving circuit, timing control circuit (not shown), and gamma calibration circuit (not shown), for driving the LCD panel to display images. Since the function of the driving module is well known in this art, the detailed description thereof will be omitted here. To be noted, the above-mentioned matrix substrate is for illustrations only and is not to limit the invention. The point of this embodiment is that the encoded signal is transmitted from the matrix substrate to the operation apparatus through the row electrodes S₁˜S_{M} and/or the column electrodes D₁˜D_{N} so as to generate the transmission signal. The encoded signal may contain various information for different applications such as the reference coordinates of the display screen, the file information of different formats (e.g. personal data, music, images, and etc.), and the likes.

In this embodiment, the column electrodes D₁˜D_{N} can transmit not only the data signals for displaying images but also the encoded signal. For example, the display signal can be directly added to the encoded signal with higher frequency or be added to the blank period of the displayed data signal such as the period after the scan procedure of all row electrodes S₁˜S_{M} are finished and before the next scan procedure start (the blank period between frames). Or, the display signal can be inserted after one row electrode is scanned and before the scan of next row electrode, or within the scan period of row electrode by reducing the display data signal period and before sending the display data. Herein, the encoded signal can be provided by expending T-con circuit function and data or scan driving circuit, thereby simplifying the circuit design.

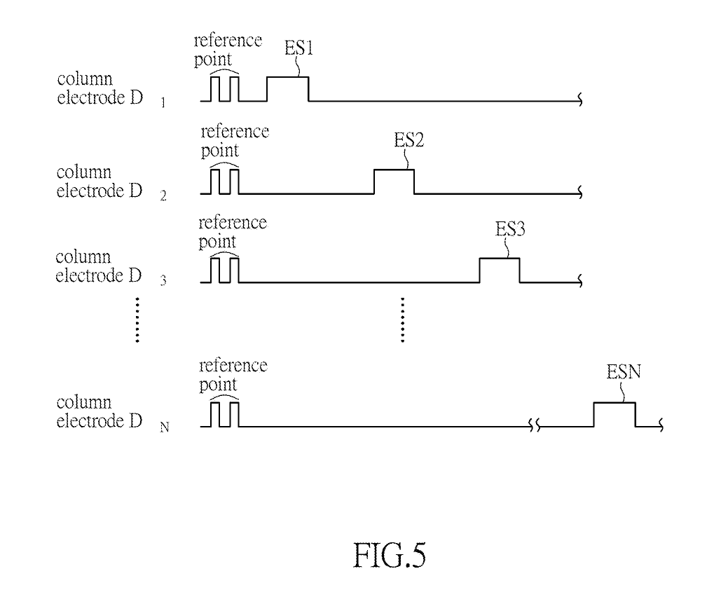

FIG. 4 is a schematic diagram showing the signals for two adjacent row electrodes and two adjacent column electrodes. The row electrodes S₁˜S_{M} transmit the scan signals SS, respectively, for sequentially turning on the transistors of each column. During the period that the transistors of each column are turned on, each of the column electrodes D₁˜D_{N} respectively transmits the corresponding encoded signal ES and the displayed data signal DS. The encoded signal ES will be described hereinafter by taking one dimension touch input perpendicular to the row electrode and sequentially encoded in time as an example. Of course, this method can also be applied to another dimension touch input perpendicular to the column electrode. Consequently, a complete two-dimensional touch input can be built. In this embodiment, as shown in FIG. 4, only one column electrode transmits the encoded signal ES when one row electrode transmits the scan signal. In this figure, the encoded signal ES is labeled with a level different from that of the displayed data signal DS; or, in practice, the encoded signal ES and the displayed data signal DS may have the same level.

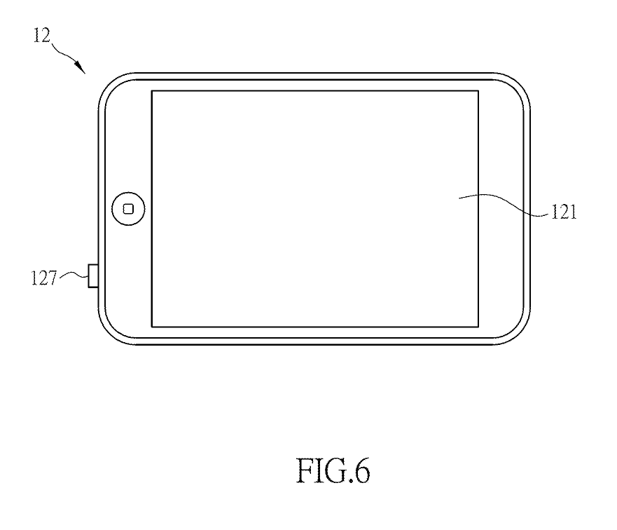

FIG. 5 is a timing chart of the encoded signal transmitted through each column electrode, wherein the data signals for display are omitted. When the row electrodes transmit the scan signals, the column electrodes D₁˜D_{N} transmit the encoded signals ES1˜ESN, respectively. To be noted, the encoded signals can be transmitted through different column electrodes, respectively, or multiple column electrodes may transmit the same encoded signal. For example, the column electrodes D₁˜D₃ transmit the encoded signal ES1. This approach may also be applied to the transmission of encoded signals through the row electrodes. Alternatively, the encoded signals transmitted through the row electrodes and the column electrodes may be independent. Since the column electrodes transmit the encoded signals ES, respectively, it is necessary to provide a time reference point for determining the positions of the column electrodes by comparing with the reference point. This reference point can be a specific code and transmitted by the same manner. For example, all column electrodes may output the code “1” twice and then transmit the sequential signal. As mentioned above, if the encoded signal coupled to the operation apparatus is “110010000”, it represents that the operation apparatus is located on the third column electrode, thereby figuring out the coordinate (x-coordinate) of the operation apparatus. Similarly, the y-coordinate of the operation apparatus can be estimated according to another encoded signal applied to the row electrode. Since the scan signals from the row electrodes for driving the display signal are sequentially generated, they can also be used as the encoded signals of the row electrodes. The encoded signals of the row electrodes and the column electrodes may have a common reference point such as the horizontal or vertical sync signals for displaying images. Of course, the column electrodes D₁˜D_{N} and the row electrodes S₁˜S_{M} may have more complicated encoded signals, which will not be described in detail here.

The duty cycle of the encoded signal of this embodiment is smaller than that of the data signals so as to maintain the display quality.

When a user grabs the operation apparatus 11 and operates it on the display surface 121 of the matrix display apparatus 12 (e.g. to contact or approach the display surface), the encoded signal is capacitive coupled from the matrix substrate assembly 122 to the operation apparatus 11. This embodiment takes the column electrodes D₁˜D_{N} for transmitting the encoded signals ES for an example, so the column electrode can serve as one of the capacitive coupling electrodes, and the operation apparatus 11 has the other capacitive coupling electrode. For example, when the operation apparatus 11 is a stylus, a conductor configured at the tip of the stylus functions as the other capacitive coupling electrode.

After receiving the encoded signal ES through the capacitive coupling, the operation apparatus 11 processes the received encoded signal ES to generate a transmission signal TS. This process includes amplifying and/or decoding the encoded signal ES so as to determine the touch position, the touch gesture (writing style), the corresponding function instruction, or which column electrode is touched or pressed. To be noted, the encoded signal ES is capacitive coupled to the operation apparatus 11, and the value of the capacitance relies upon the distance between the operation apparatus and the display surface, which means the amplitude of the signal can provide the z-axis information, so that the operation apparatus 11 can get not only the two-dimensional coordinates but also the z coordinate. Accordingly, the transmission signal TS stands for the result of processing the encoded signal ES, ranging from simple amplification to extract the information like commands of action.

After generating the transmission signal TS, the operation apparatus 11 can transmit the transmission signal TS to the matrix display apparatus 12, other relay apparatus, or other apparatuses outside the visual interface system through wire/wireless electrical coupling (including capacitive coupling) or optical coupling. In this embodiment, the transmission signal TS is directly transmitted to the matrix display apparatus 12.

When this invention is applied to other non-touch input applications, the information to be transmitted is encoded to generate an encoded signal ES based on a specific coding rule. Then, the encoded signal ES is capacitive coupled from the matrix substrate assembly 122 (e.g. configured as a cell phone or tablet computer) to the operation apparatus 11 (e.g. short distance wireless reading apparatus attached on the wall). Similarly, the operation apparatus 11 can process (decodes or modifies) the encoded signal ES based on the preset coding rule so as to obtain the transmission signal TS, and then uses the transmission signal TS on the corresponding application such as access control, payment, financial transaction, file transmission, and the likes.

In the above, the operation apparatus 11 processes the encoded signal ES to obtain the information contained in the transmission signal TS such as the touch input information, instruction information, identification information, transaction information, file information or other information. In other embodiments, the matrix display apparatus 12 may process the transmission signal TS to obtain an information signal, which contains the touch input information, instruction information, identification information, transaction information, file information or other information. In this case, the information signal, instead of the transmission signal TS, carries the complete information.

As mentioned above, referring to FIG. 1, in the procedures of coupling the encoded signal ES to the operation apparatus 11 to generate the transmission signal TS and transmitting the transmission signal TS to the matrix display apparatus 12 to obtain the information signal, the signal is processed by, for example, amplification and decoding, which can be handled by either one of the operation apparatus 11 and the matrix display apparatus 12 or among these units. Accordingly, the resulting transmission signal TS or the information signal can contain the touch input information, instruction information, identification information, transaction information, file information or other information.

Besides, a response signal RS can also be transmitted between the operation apparatus 11 and the matrix display apparatus 12. Herein, the response signal RS is for providing the information of the receiving status of the operation apparatus 11 to the matrix display apparatus 12, announcing the operation apparatus 11 to get ready for receiving the signal, or synchronizing the operation apparatus 11 and the matrix display apparatus 12. This configuration can create an interactive mechanism between the transmitting and receiving signals. Moreover, the response signal RS can provide the synchronization function for establishing an information handshaking procedure between the operation apparatus 11 and the matrix display apparatus 12.

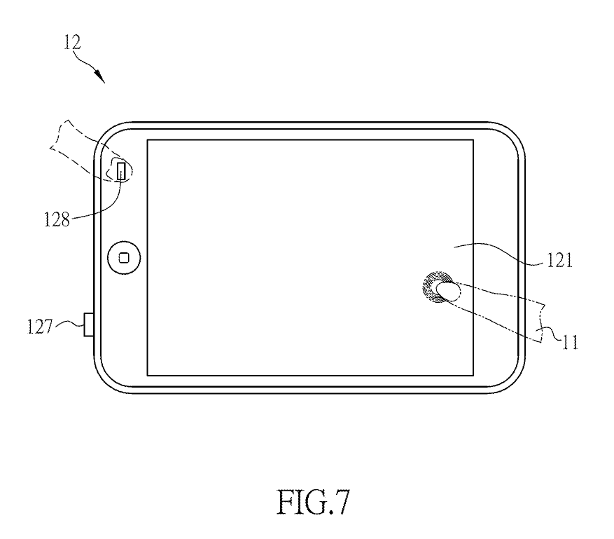

FIG. 6 is a schematic drawing of the matrix display apparatus 12 of the visual interface system according to the first embodiment of the invention. Referring to FIG. 6, the visual interface system further includes a mode trigger apparatus 127. When a user or the operation apparatus triggers the mode trigger apparatus 127, the mode trigger apparatus 127 can enable the matrix display apparatus 12 into an operating mode to output the encoded signal ES. For example, when the user needs the touch input function, he/she activates the mode trigger apparatus 127 so as to enable the matrix display apparatus 12 into the touch input mode. Then, the row electrode or column electrode starts to transmit the encoded signal. Otherwise, the matrix display apparatus 12 does not enter the touch input mode and the touch input function of the matrix display apparatus 12 may be partially or totally shut down. This function can save power and prevent the abnormal operation caused by unintentionally contacting the screen. To be noted, the operation of the mode trigger apparatus 127 may have different operation modes. For example, after being activated, the mode trigger apparatus 127 may remain in the new state for a while and then return to the original state, or it may change the state while been activated each time, or it remains in the new state only when the activation lasts. The mode trigger apparatus 127 can be configured on the operation apparatus (e.g. a switch on the stylus) as well. In this case, when the mode trigger apparatus 127 is activated, the operation apparatus 11 transmits a trigger signal to the matrix display apparatus 12 to control it to enter the touch input mode. To be noted, it is possible to switch to touch input function when the mode trigger apparatus 127 is activated once by the user or requests the user to keep activating the mode trigger apparatus 127 to maintain in touch input function. Taking the access card, ticket, credit card or file transmission as examples, the user can trigger the mode trigger apparatus to transmit the encoded signal for authorization or personal identification to the corresponding data receiving device. The mode trigger apparatus 127 can be, for example, a mechanical switch, a touch sensing switch, or the likes.

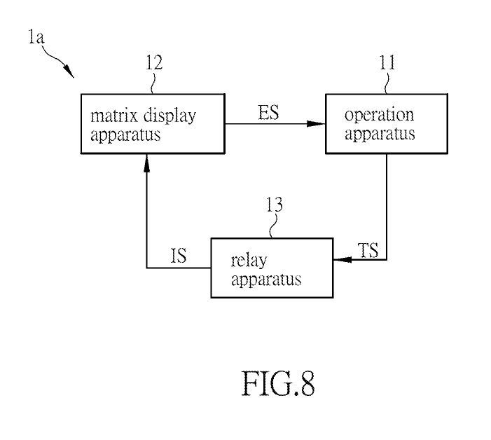

FIG. 7 is a schematic diagram showing the matrix display apparatus 12 and a user for conducting signal to the operation apparatus 11, of the visual interface system 1 according to the first embodiment of the invention. In this aspect, the visual interface system 1 further includes a sensing apparatus 128, a data receiver as the operation apparatus 11, which is electrically coupled with the matrix display apparatus 12. When the user touches or approaches the display surface 121 and the sensing apparatus 128 of the matrix display apparatus 12 simultaneously, the transmission signal TS is transmitted to the matrix display apparatus 12. The user serves as a large conductor for transmitting the encoded signal ES to the sensing apparatus. In practice, the user can use his/her right hand to operate on the display surface 121, while use the left hand to press the sensing apparatus 128. Accordingly, the encoded signal ES can enter the user body through the right hand, and output from the left hand. The sensing apparatus 128 may also contain the function of the mode trigger apparatus 127. For example, only when the sensing apparatus 128 is pressed by hand, the operation mode will be enabled. This specific function can sufficiently reduce the power consumption and problem of unintentional touch.

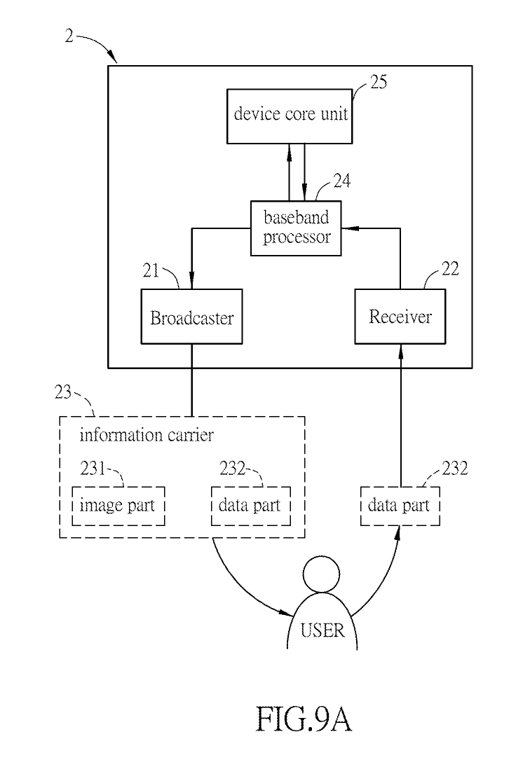

FIG. 8 is a block diagram of a visual interface system 1a according to a second embodiment of the invention. The visual interface system 1a includes an operation apparatus 11 and a matrix display apparatus 12. Different from the first embodiment, the visual interface system 1a further includes at least one relay apparatus 13, and the transmission signal TS is transmitted to the matrix display apparatus 12 or other apparatuses outside the visual interface system through the relay apparatus 13. Transmitting the transmission signal TS through user's hand to a relay apparatus 13 will be used to describe the implementation of this embodiment. From the transmission signal TS, the relay apparatus 13 generates a relay processed signal IS and transmits back to the matrix display apparatus 12. The relay apparatus 13 is only for illustration and it is possible to configure multiple relay apparatuses. When a user (or the user's hand) serves as a conductor or a wire to transmit the encoded signal ES from the matrix display apparatus 12 to operation apparatus 11, the operation apparatus 11 can transmit the transmission signal TS to the relay apparatus 13 instead of transmitting back to the matrix display apparatus 12. Herein, the relay apparatus 13 can be a portable communication device such as a cell phone. Accordingly, the user can be the transmission media for conducting the encoded signal ES outputted from the matrix display apparatus 12 to the relay apparatus 13 for the purpose of transmitting file information.

The relay apparatus 13 can process the transmission signal TS to generate a relay processed signal IS and then transmit the relay processed signal IS to the matrix display apparatus 12. In the procedures of coupling the encoded signal ES to the operation apparatus 11 to generate the transmission signal TS, processing the transmission signal TS by the relay apparatus 13 to generate the relay processed signal IS, and transmitting the relay processed signal IS to the matrix display apparatus 12 to obtain the information signal, the signal is processed by means, for example, amplification, decoding, modifying and/or interpretation, which can be implemented by all or either one of the operation apparatus 11, the matrix display apparatus 12 and the relay apparatus 13. Accordingly, the transmission signal TS, the relay processed signal IS or the information signal can contain the touch input information, instruction information, identification information, transaction information, file information or other information.

Besides, the response signal RS of the first embodiment can also be applied to the operation apparatus, relay apparatus and/or matrix display apparatus of the second embodiment, thereby creating an interactive mechanism between the transmitting and receiving signals. Moreover, the response signal RS can provide the synchronization function for establishing an information handshaking procedure between the operation apparatus, relay apparatus and matrix display apparatus.

In the visual interface system of the invention, when the operation apparatus is operated on the display surface, the encoded signal is coupled to the operation apparatus from the matrix substrate, and the operation apparatus receives the encoded signal to generate a transmission signal. In touch input application, the transmission signal can be directly or indirectly transmitted to the matrix display apparatus. During this transmission procedure, the transmission signal can be processed by operation apparatus, at least one relay apparatus, and/or the matrix display apparatus, so that the matrix display apparatus can retrieve the information contained in the encoded signal and transmission signal, such as touch input information, instruction information, identification information, transaction information, file information or other information.

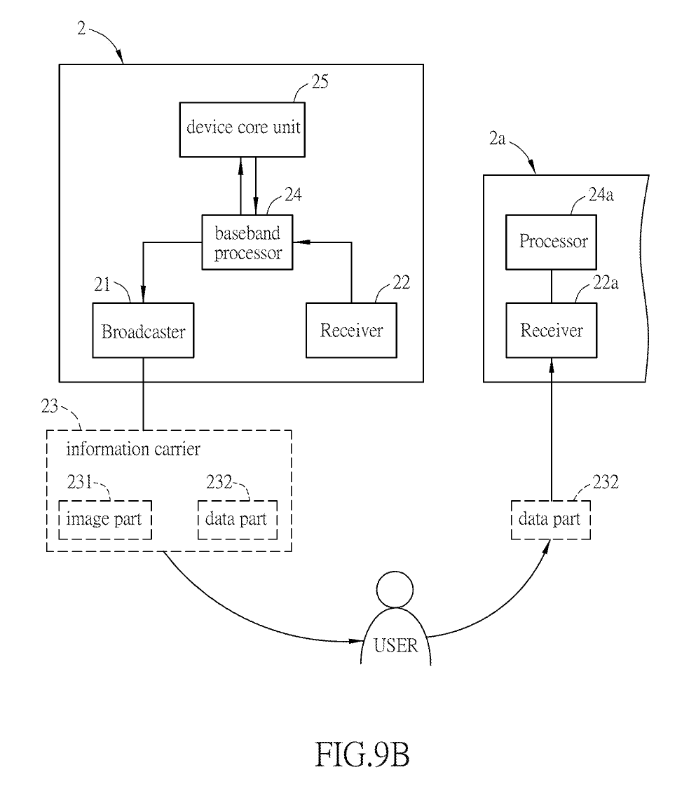

Moreover, this disclosure also provides a short-range information broadcasting system. Please refer to FIGS. 9A and 9B, which are two schematic diagrams of the short-range information broadcasting system 2 according to the embodiments of this invention. The short-range information broadcasting system 2 comprises a broadcaster 21 and a receiver 22. The broadcaster 21 comprises a display matrix 211, and the display matrix 211 generates and broadcasts at least one information carrier 23. Outside the broadcaster, the information carrier 23 comprises an image part 231 and a data part 232. The image part 231 and the data part 232 represent the same information content or same information. The receiver 22 receives the data part 232 of the information carrier 23. The short-range information broadcasting system 2 may further comprises a device core unit 25 and a baseband processor 24 that electrically couples to the broadcaster 21 and the receiver 22 and controls them. The baseband processor 24 receives and processes data from the device core unit 25 and delivers the result to broadcaster 21. Based on the result, the broadcaster 21 generates signals and broadcast information carrier 23 out of the broadcaster 21. The baseband processor 24 will also process the data received by receiver 22 and send the information to device core unit 25. Moreover, the device core unit 25 is electrically coupled to the baseband processor 24 and is responsible for other functions of short-range information broadcasting system 2, such as storing programs, computing, and/or controlling other input/output interfaces thereof.

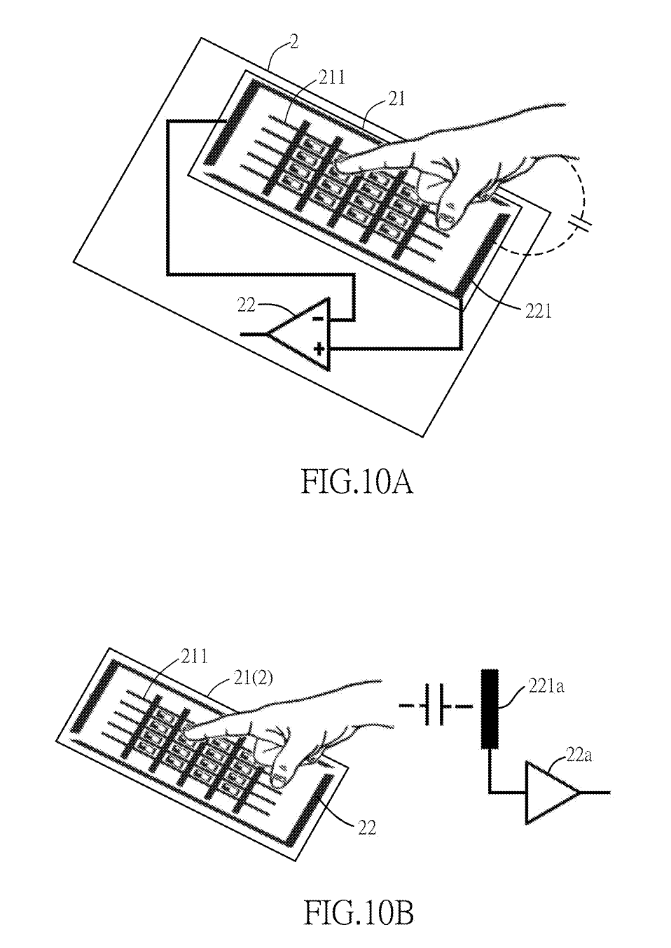

In this embodiment, the broadcaster 21 may correspond to and be substantially the same as the matrix display apparatus 12 described in the previous embodiments, and therefore the display matrix 211 may correspond to and be substantially the same as the matrix 124 (or the matrix substrate assembly 122) of the matrix display apparatus 12. The receiver 22 may correspond to and be substantially the same as the operation apparatus 11. Also, inside the broadcaster 21, a signal that comprises the display signal DS including data and scan signal (for generating the “image part 231”) and the encoded signal ES (for generating the “data part 232”) described in the previous embodiments can generate the information carrier 23 outside the broadcaster 21. For example, the receiver 22 and the broadcaster 21 can be located on the same device (as shown in FIG. 9A), or the receiver 22a and broadcaster 21 can be located on separate devices (as shown in FIG. 9B). As shown in FIG. 9B, the receiver 22a is disposed on another device 2a (which comprises a processor 24a which electrically couples to the receiver 22a and controls it), while the broadcaster 21 is disposed on the short-range information broadcasting system 2. While the receiver 22 and the broadcaster 21 are located on the same device (i.e., the same the short-range information broadcasting system 2), the receiver 22 is located on a surrounding of the broadcaster 21 (as shown in FIG. 10A).

In the present short range communication system 2, the information carrier 23 is designed to contain both image and data outside the matrix display apparatus 12. It means attaching data to an icon like a label so that the combination brings the same information to user and the receiver (22 in FIGS. 9A and 10A and 22a in FIGS. 9B and 10B). The requirement of “same information” implies the connection, or dependence, between visual input and the action. It also ensures the response of system 2 in FIG. 9A and system 2a in FIG. 9B will consist with user's expectation. This composite information entity forms a basic information unit for both user-device and device-device interactions. It is possible to attach data that is meaningful to the short-range information broadcasting system 2 and to other device 2a. In other words, the entity can serve as an information carrier for user input and for short-range data transmission. This informant entity can be defined as information with two incarnations that carrying same information, one for user and the other for the receiver (22 or 22a). Based on this new entity, it is then possible to convert action into information that receiver 22 or 22a can recognize. The information carrier 23 is named as a “Data Embedded Graphic Element (DEGE).” Outside the broadcaster, DEGE is a basic information unit that a graphic element (i.e., the image part 231) is associated with data (i.e., the data part 232). The image part 231 and the data part 232 will carry the same information but for different recipients. In other words, an information carrier 23 has two different labels, the image part 231 and the data part 232. The image part 231 and the data part 232 will occupy the same physical space so that an intuitive action on the image part 231 will also form a signal path to transmit the data part 232. For example, the image of character ‘A’ can combine with its ASCII code “41H” and forms an information carrier 23 (or namely, a DEGE). They represent the same information but the image part 231 is for user while the data part 232 is for device. The information carrier 23 is a flexible way to associate any data with its image part 231. For example, in addition to 41H, the data part 232 may also include the font image of character ‘A’. Then, it is possible to reconstruct the complete information carrier 23 based on its data part 232.

Present user input relies on position to link the image part 231 and the data part 232. In detail, action is converted to the data part 232 in two steps, action to position by touch panel and position to the data part 232 by GUI. GUI uses the image-position mapping to obtain the data part 232. This methodology involves three different conversions, image to position, action to position, and position to data, and includes hardware and software. Position connects all these together. However, position as a metadata of the image is meaningful only when referring to that particular image frame. The aforementioned “metadata” is a data to provide information of the other data. For example, shutter speed of a picture is a metadata. It is meaningful only to that picture. In this case, the digital data (the data part 232) replaces the analog position and it can be encrypted so that more than one receiver such as 22 and 22a can decipher. Also, the data part 232 can be encrypted as the indexes of the image parts 231 arranged in a specific sequence. The sequence becomes a key to decipher the index. Thus, there are various ways to represent data part 232 other than using position.

In addition, a user can use his/her finger for inputting by transmitting signal through body to the receiver 22. T. G Zimmerman has demonstrated that human body can function like a wire for transmitting signals in 1996. He demonstrated the body could bridge signal to either ground or a receiver for position detection. Grounding signal through body is to detect the deviation of a preset signal caused by grounding and is widely adopted in present capacitive sensing. Zimmerman also demonstrated the body can deliver a reference signal to two receivers for detecting distance in x and y direction like RADAR. Later on, body as a signal path has been used for delivering biological signals to medical device or wearable sensing unit in body area network (BAN) or body sensor network (BSN). In this case, it is also possible to adopt body as a signal path for delivering data to receiver. Most importantly, it can be considered as an action-to-data conversion that the received data will represent the action for establishing signal path.

For implementation, the broadcaster 21 may be configured as below. As mentioned above, the broadcaster 21 of the short-range information broadcasting system 2 is a display (i.e., the display matrix apparatus 12 of the previous embodiment) that can transmit data related to the image. There are various ways to achieve this and the details will be discussed. First, we may consider the broadcaster 21 of the short-range information broadcasting system 2 as a panel that can display image frame and data frame although it does not need to strictly follow such frame structure. Moreover, the receiver 22 is installed so that the user can easily perform the transmission of the information carrier 23. As shown in FIG. 10A, the receiver 22 may comprises coupling electrodes 221 that are installed on the edge of broadcaster 21 for receiving the data part 232 of the information carrier 23 from finger input as intra-device transmission. An electrode on stylus tip can serve for stylus input. As shown in FIG. 10B, a coupling electrode 221a of another receiver 22a on another device can serve for extra-device transmission of the information carrier 23. It is possible to install coupling electrodes on various surfaces of a device to facilitate the usage of intra- and extra-device transmissions in various situations.

Moreover, to convert a flat display panel into a broadcaster, an AMLCD may be used. The matrix 124 (as shown in FIG. 3) of the matrix display apparatus 12 may act like antennas that can also transmit the data part 232 in addition to the image part 231. Broadcasting the information carrier 23 comprising the image part 231 and the data part 232 outside the broadcaster is an issue of transmitting two different signals, image and data, from the display matrix so that they can form image and data respectively. We may think the antenna (the matrix 124) transmits information carrier with different parts to their respective receiver(s). Meanwhile, the electrical receiver 22 may extract the data part 232 from the information carrier 23 only. The techniques in data communication such as time or frequency multiplexing can be applied in this case.

In addition, the matrix display apparatus 12 is arranged in a reverse order comparing to traditional TFTLCD. The matrix 124 is disposed on the “bottom” side of the upper substrate 123 (as shown in FIGS. 2 and 3, the TFT matrix 124 is disposed on the side of the upper substrate 123 which is away from the display surface 121 with respect to the side which the protect glass 125 is attached on). This avoids the interference caused by the common electrode or other parts of the display apparatus 12 when the receiver accesses the data part 232 of the information carrier 23 from the matrix 124. It is equivalent to flip the panel in module assembly so that the TFT substrate is on the viewing side (the upper substrate of the LCD module that is close to the viewer) rather than the color filter substrate (the bottom substrate of the LCD module which is near the light module). In this reverse setup structure, the upper side of the matrix 124 is dedicated to the receiver 22 for accessing the near field signals (i.e., the information carrier 23).

To arrange signals for image part and data part on the matrix requires further consideration. For the flat display panel such as liquid crystal display panel, high frequency signals (for example ˜MHz signals) may be used for the data part 232 and be added directly onto display signals (i.e., the image part 231). Then, th electrical receiver 22 can adopt a high pass filter to reject display signals (i.e., scan and data line signals for the image part 231) transmitted by the display matrix of a LCD. It is the same as frequency division in communication. For the flat display panel with fast response speed such as an OLED, it would require much higher frequency for the data part 232. Another approach is to offset the transmission of image part and data part in space (spatial separation). An active matrix can be operated in two different modes that pixel electrodes E₁₁˜E_{MN} of the matrix 124 are only for forming the image parts 231 while line electrodes (S₁˜S_{M} and D₁˜D_{N}) of the matrix 124 are for transmitting display signals (i.e., the image parts 231) and the data signals (i.e., the data parts 232). In other words, the matrix 124 operates as an active matrix for displaying image (i.e., using traditional scan and data line signals to generate the image parts 231) and passive matrix for the data transmission (i.e., turn off TFTs while transmitting the data parts 232). This requires the scan line signal level well below the TFT turn-on voltage when transmitting the data signals (i.e., the data parts 232). Because transmitting the data signals (i.e., the data parts 232) will occupy certain time of line electrodes, this spatial separation method does not affect images but the frame rate. It prefers to use high frequency signals for the data signals (i.e., the data parts 232) and separate the data signals (i.e., the data parts 232) from image signals (i.e., the image parts 231) at the receiver 22.

When the matrix display apparatus 12 acts as the broadcaster, it will provide a variable, rather than fixed, image frame rate. Sharing line electrodes (including the row electrodes S₁˜S_{M} and the column electrodes D₁˜D_{N}) for transmitting the data parts 232 is the same as sharing the data rate bandwidth of matrix between the image parts 231 and the data parts 232. As the frame rate is for creating motion effect rather than forming the image, the matrix display apparatus 12 when acts as the broadcaster 21 can set an upper limit to the bandwidth for transmitting the data parts 232 and maintain a minimum image frame rate. The minimum frame rate is a content dependent parameter. For example, screen during text editing may afford lower frame rate than gaming. The frame rate may varies from 60 down to 50 Hz as the minimum, i.e. extending frame period from 16 to 20 msec. This creates a 4 msec time slot for transmission of the data signals (i.e., the data parts 232) while maintaining 16 msec for image (i.e., the image parts 231). The time slot would be longer for higher frame rate panel such as 120 Hz.

In practice, the transmission may be simplified in intra-device case and different protocols can be adopted for intra- and extra-device transmission instead of one protocol. This will optimize the performance of the matrix display apparatus 12 when it act as the broadcaster 21 and reduce the impact to frame rate. Thus, the matrix 124 of the matrix display apparatus 12 can broadcast the information carrier 23 for intra-device by default and for extra-device when is necessary, or vice versa.

The self-receiving structure of intra-device provides a simple way to encode the data part 232 for transmission. One way is to replace the data parts 232 by the index of information carriers 23 arranged in an arbitrary order. A variant of this indexing method is to index according the row/column line numbers of image parts 231. The data part 232 represents a pair of indices and can be decoded when the arrangement of the image part 231 is known. It is similar to the concept of input by position but replacing analog position by the digital indices. The transmission of the data part 232 becomes the transmission of indices.

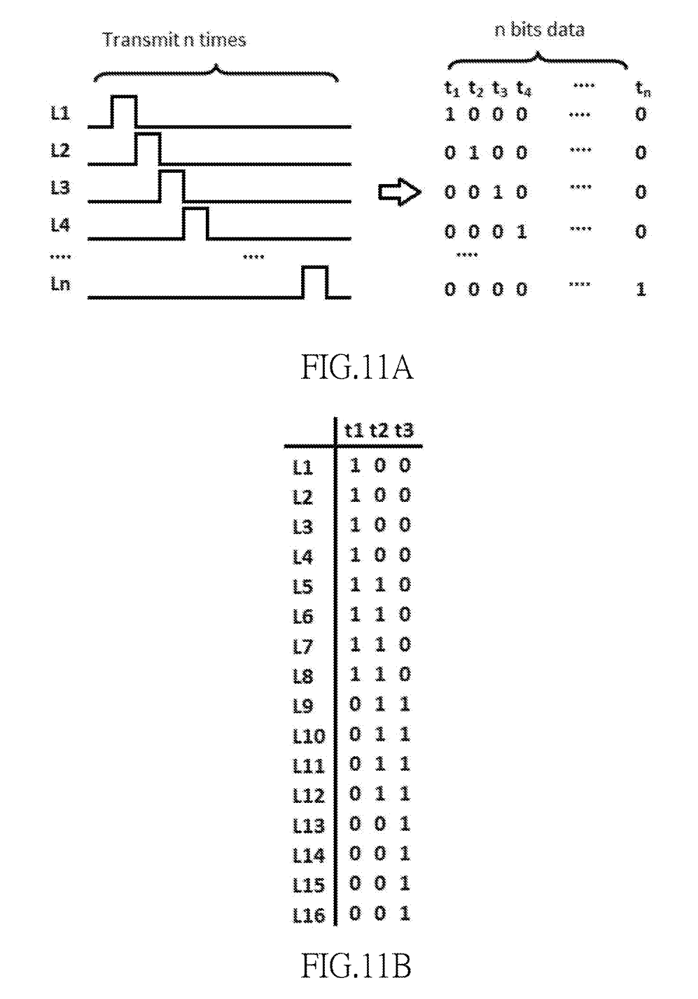

To encode index into signals, as shown in FIG. 11A, an index can be encoded in the pulse sequence similar to the scan line signals for displaying images. For n lines, this will require n pulses and is the same as transmit an n-bit data on each line. Two such pulse sequences may be arranged on scan and data lines respectively and, when coupled to receiver, they are converted into scan and data line indices. As an example, 1 μsec pulse duration may cost 4 msec to broadcast 4000 scan and data lines in total.

A more efficient way is to treat the index transmission as an interactive channel search, like binary search. It is possible to start initial search with low resolution for detecting only the existence of a transmission path. When a path exists, the search is refined iteratively by focusing on the possible region with higher resolution until the maximum resolution is reached or the result is satisfactory. FIG. 11B shows an example of searching among 16 lines. Three pulses (3 bits data) may be used to decide whether a path appears in L1˜L8, L5˜L12, or L9˜L16. If detected, said L5˜L12, the signals can be rearranged to detect path within L5˜L12 again. Same as binary search, each iteration reduces the width of searching region by half. The purpose of 3 bits data is to remove the ambiguity when channel exists within the boundary region said L7˜L10. This searching algorithm requires only 3m bits instead of 2m bits to locate a single line among 2^{m} lines. In other words, for 4096 lines (say 1024 scan lines and 3072 data lines), the time shared for the data part 232 is reduced to 66 μsec (i.e., 30 and 36 bits data for searching scan and data lines respectively) instead of 4 msec. In practice, the search may terminate when reaching a certain region than a line. It may require more complicated algorithm to handle multiple channels (corresponding to the multi-touch in a touch panel) situation. In general, search can respond faster for it requires only 3 bits (i.e., 3 μsec) to detect a channel initially. Such a small size data transmission may be inserted between the image scan lines (said at every 10 scan lines) so that the matrix 124 can respond timely to the existence of a path. When a path is detected, the short-range information broadcasting system 2 may prioritize the transmission of index to every scan line so that a line can be located less than 120 scan lines, i.e. 60 search steps for each direction. For 60 Hz frame rate and 1000 scan lines, path can be located within 2 msec or 500 Hz reporting rate. These values are for depicting the concept and the actual number may vary according to the search algorithm. This is an example that it is possible to change the data part 232 dynamically (transmit different information carriers 23) within channel existing period and transmit the data part 232 between image lines rather than grouped into an independent frame.

For practical applications, scan driver requires a major change. It should be able to address each line independently and randomly. Scan driver needs to adopt similar structure as data driver instead of simple shift register. It also requires a third output level, said Vgd, in addition to the Vgh and Vgl for turning TFT on and off. Vgd and Vgl constitute the two levels for transmitting indices on scan lines. Furthermore, as shown in FIG. 10A, the receiving electrodes 221 (which act for the receiver 22) can also be located on the display panel. Such display panel is a transceiver assembly (a broadcaster 21 and a data receiver 22) for display, user input, and short range data transmission.

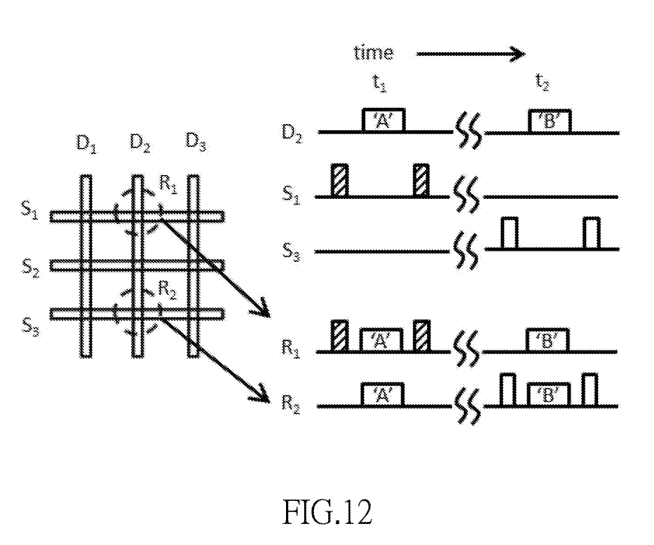

Unlike intra-device transmission, data transmitted through extra-device relies on a standardized protocol for operation. However, some unique features of such matrix display apparatus 12 should be noted while establishing the protocol. Multiple scan or data lines for displaying the image part 231 will transmit its partnering data part 232. Thus, such matrix display apparatus 12 may have different lines that transmit the same signal. Because a coupling will include both scan and data lines simultaneously, the matrix display apparatus 12 can use data lines for transmitting the data parts 232 and scan lines for transmitting delimiters for separating the data parts 232 on the same data lines (as shown in FIG. 12). The receiver 22 can retrieve the correct data part 232 based on the presence of scan signal. During extra-device transmission, more time can be allocated to broadcast information carriers 23 (especially for the data parts 232) because the screen content is nearly static and afford a lower frame rate. In addition, based on the above panel transceiver, it is possible to evoke the intra- and extra-device transmission simultaneously in an action. The matrix display apparatus 12 can issue extra-device transmission right after the intra-device and devote the full bandwidth to transmit those selected data parts 232 for extra-device transmission. Combining intra- and extra-device transmission in one action is a unique feature of this system and may create new interactions for users (Hsiung-Kuang Tsai, Action range communication (ARC): A digital architecture for user and device interaction, 2017, Journal of the SID, 25:8, 486-95).

Accordingly, the short-range information broadcasting system according to the inventive concept of this disclosure considers user-device interaction as information transmission that includes data transmission as part of the process. In such transmission, the information carrier has two different parts, image part and data part, while actions join in establishing a transmission channel. Interaction becomes an information transmission within action range. From the viewpoint of information recipient, this interaction is the same as a data transmission. Display matrix can deliver signals for not only image but also data and serve as a broadcaster for broadcasting the information carrier. Panel will become an information transceiver that provides display, on-screen input, and short-range-data-transmission. This will compact device architecture in both hardware and software. The information carrier is an information structure that user can see and move by action. This provides another way to merge the digital and the real world together. In the short-range information broadcasting system, users can directly interact with multiple devices and may result in a new cyborg input. Extensive developments are required in the future including a ‘baseband’ processor and a standard protocol for extra-device transmission.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A short-range information broadcasting system comprising:
a broadcaster which comprises a display matrix, wherein the display matrix generates and broadcasts at least one information carrier, the information carrier comprises an image part and an data part, and the image part and the data part share common information, and
a receiver which receives the data part of the information carrier.

2. The short-range information broadcasting system according to claim 1, wherein the receiver and broadcaster are located on the same device.

3. The short-range information broadcasting system according to claim 2, wherein the receiver is located on a surrounding of the broadcaster.

4. The short-range information broadcasting system according to claim 1, wherein the receiver and broadcaster are located on separate devices.
